(19) United States
(12) Patent Application Publication
(10) Pub. No.: US 2025/0382047 A1
(43) Pub. Date: Dec. 18, 2025

(54) COMPOSITE PANELS WITH TITANIUM ENDS

(71) Applicant: The Boeing Company, Arlington, VA (US)

(72) Inventors: Michael Kenneth-Que Louie, Renton, WA (US); Scott Michael Spencer, Everett, WA (US); Marianne Elizabeth Wilkinson, Redmond, WA (US)

(21) Appl. No.: 18/816,931

(22) Filed: Aug. 27, 2024

Related U.S. Application Data
(60) Provisional application No. 63/660,313, filed on Jun. 14, 2024.

(51) Int. Cl. B64C 3/26; B29C 65/00; B29L 31/30

(52) U.S. Cl. CPC B64C 3/26; B29C 66/128; B29C 66/7428; B29L 2031/3085

(57) ABSTRACT

A composite structure and methods of forming are presented. A composite structure comprises: structural supports and a structural skin formed by a plurality of composite panels fastened to the structural supports. Each composite panel of the plurality of composite panels comprises a first titanium end; a second titanium end; and a composite skin joined to and extending between the first titanium end and the second titanium end.

### CROSS-REFERENCE TO RELATED APPLICATION

This application claims the benefit of Provisional U.S. Patent Application No. 63/660,313 filed Jun. 14, 2024, which is incorporated by reference herein in its entirety. This application is related to the following U.S. Patent Application entitled “Metal to Composite Joints,” Ser. No. ______, attorney docket no. 23-2202-US-NP, filed even date hereof, assigned to the same assignee, and which is incorporated by reference herein in its entirety.

### BACKGROUND INFORMATION

### 1. Field

The present disclosure relates generally to composite skins and more particularly to composite panels.

### 2. Background

Composite manufacturing has challenges for large structures. Traditionally large composite skins have been manufactured as a single large continuous piece. Manufacturing large continuous composite skins can present challenges for maintaining timelines, reducing costs, and for maintenance or repair.

Manufacturing composite skins as multiple discrete portions presents challenges in joining. Traditional fasteners introduce inconsistency points within the composite skins.

Therefore, it would be desirable to have a method and apparatus that takes into account at least some of the issues discussed above, as well as other possible issues. It would be desirable to have methods of improved composite manufacturing. It would be desirable to have methods of manufacturing composite skins.

### SUMMARY

An embodiment of the present disclosure provides a composite structure. The composite structure comprises a structural support and a structural skin comprising a composite panel fastened to the structural support. The composite panel comprises a first titanium end, a second titanium end, and a composite skin joined to and extending between the first titanium end and the second titanium end.

Another embodiment of the present disclosure provides a composite structure. The composite structure comprises a composite panel fastened to the composite structure at titanium ends. The composite panel comprises two titanium ends and a composite skin joined to and extending between the two titanium ends.

Yet another embodiment of the present disclosure provides a method of forming a composite structure comprises bonding composite skins to respective first titanium ends and respective second titanium ends to form a plurality of composite panels; and fastening the plurality of composite panels to structural supports to form a structural skin of the composite structure.

Yet another embodiment of the present disclosure provides a method of accessing an internal volume of a composite structure. One-sided fasteners of a composite panel are unfastened. The composite panel comprises a first titanium end, a second titanium end, and a composite skin joined to and extending between the first titanium end and the second titanium end. The composite panel is removed from the composite structure to create an opening after unfastening the one-sided fasteners. The internal volume of the composite structure is accessed through the opening.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a top view of an aircraft wing with a wing skin comprising a plurality of composite panels in accordance with an illustrative embodiment;

FIG. 4 is an illustration of a cross-sectional view of a composite panel with metal to composite joints in accordance with an illustrative embodiment;

FIG. 5 is an illustration of a cross-sectional view of composite panels fastened to a structural support in accordance with an illustrative embodiment;

FIG. 6 is an illustration of a block diagram of a manufacturing environment in accordance with an illustrative embodiment;

FIG. 7 is an illustration of a cross-sectional view of a metal to composite joint in accordance with an illustrative embodiment;

FIG. 8 is an illustration of a cross-sectional view of a metal to composite joint in accordance with an illustrative embodiment;

FIG. 9 is an illustration of a cross-sectional view of a metal to composite joint in accordance with an illustrative embodiment;

FIG. 10 is a flowchart of a method of forming a composite structure in accordance with an illustrative embodiment;

FIG. 11 is a flowchart of a method of accessing an internal volume of a composite structure in accordance with an illustrative embodiment;

FIG. 12 is an illustration of an aircraft manufacturing and service method in a form of a block diagram in accordance with an illustrative embodiment; and

FIG. 13 is an illustration of an aircraft in a form of a block diagram in which an illustrative embodiment may be implemented.

### DETAILED DESCRIPTION

The illustrative examples recognize and take into account one or more considerations. The illustrative examples recognize and take into account that in an aircraft, a metal to composite joint can be used to join wings to the body of the aircraft. The illustrative examples recognize and take into account that the metal to composite joint can be a step lap joint between the composite plies and the metal component. The illustrative examples recognize and take into account that in large structures, metal to composite joints present manufacturing challenges.

The illustrative examples recognize and take into account that gaps may be created at each step of a step lap metal to composite joint, introducing air into the laminate. The illustrative examples recognize and take into account that on a thick large part, air and volatiles inside the laminate at the steps is undesirably difficult to evacuate during fabrication and autoclave cure. Remaining air and volatiles can lead to undesirable conditions such as porosity. To reduce inconsistencies, multiple cure cycles may be used, increasing cycle time and utilizing more resources.

The illustrative examples recognize and take into account that smaller composite parts have less issues with evacuating volatiles. The illustrative examples recognize and take into account that smaller composite parts have fewer volatiles as volatiles travel interlaminarly as opposed to through thickness. The illustrative examples recognize and take into account that air/volatiles travel significantly better between plies than through thickness.

The illustrative examples recognize and take into account that volatiles cannot move through titanium. The illustrative examples recognize and take into account that a hybrid titanium composite part will help reduce weight when compared to a titanium part.

The illustrative examples provide a new design that comprises titanium and carbon fiber composite. The titanium and carbon fiber composite can be used in airplane wing skins. In these illustrative examples, titanium is spliced to at least one end of a large composite structure.

The illustrative examples present metal to composite joints with more than one titanium component through the thickness. The illustrative examples “split” large titanium parts into two portions to allow for composite in between. The illustrative examples provide escape paths for air and volatiles through the composite layers between the titanium parts.

The illustrative examples improve both manufacturability as well as damage tolerance for titanium and composite structures. Splitting the titanium and using composite layers in between the titanium components helps manage scale for a design with titanium on the inboard side of a large wing skin or other sizeable part. The illustrative examples could be used on the inboard and outboard ends of wing skins for weight reduction.

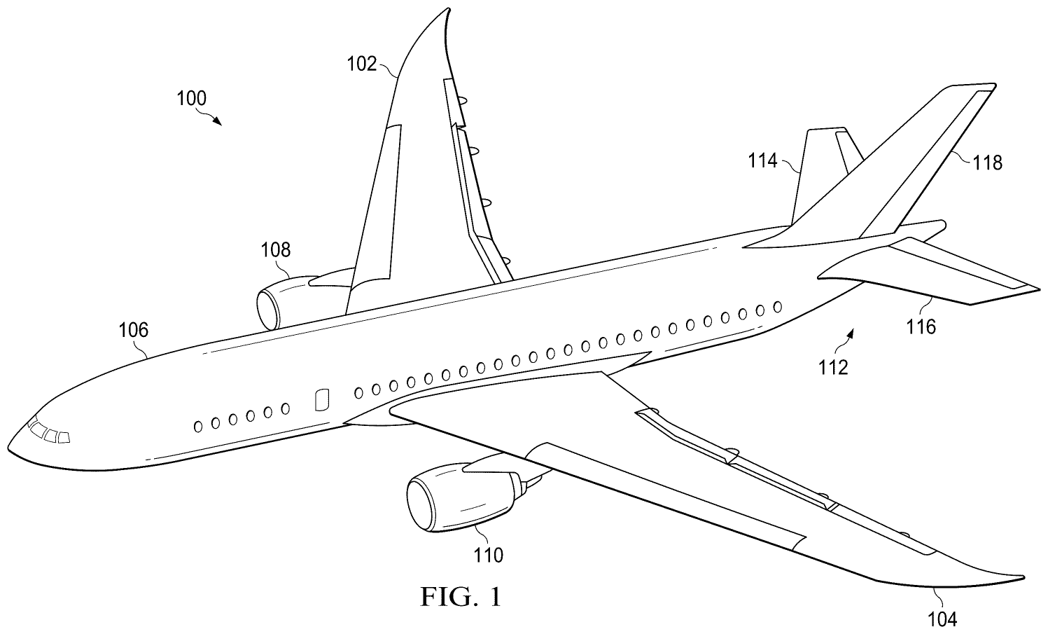

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite panels. Composite panels of the illustrative examples can be used to form a wing skin of at least one of wing 102 or wing 104.

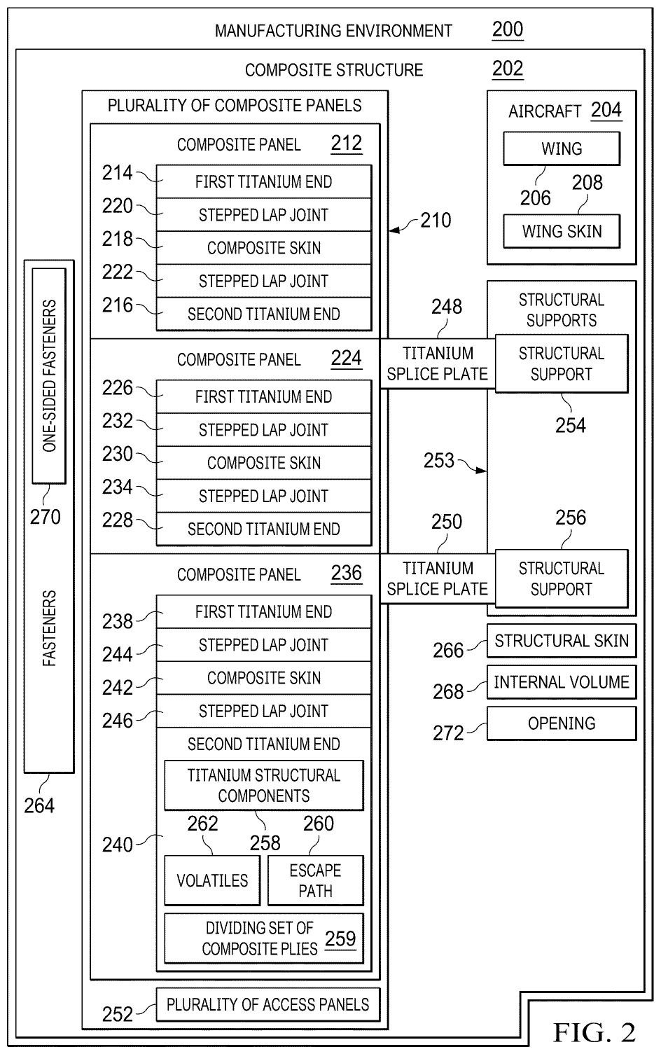

Turning now to FIG. 2, an illustration of a block diagram of a manufacturing environment is depicted in accordance with an illustrative embodiment.

Composite structure 202 comprises structural support 254 and structural skin 266 comprising composite panel 212 fastened to structural support 254. Composite panel 212 of plurality of composite panels 210 comprises first titanium end 214, second titanium end 216, and composite skin 218 joined to and extending between first titanium end 214 and second titanium end 216. Structural skin 266 comprises any desirable quantity of composite panels and is not limited by the depictions presented in the Figures.

In some illustrative examples, composite structure 202 comprises structural supports 253 and structural skin 266 formed by plurality of composite panels 210 fastened to structural supports 253. Each composite panel of plurality of composite panels 210 comprises a first titanium end, a second titanium end, and a composite skin joined to and extending between the first titanium end and the second titanium end. For example, composite panel 212 of plurality of composite panels 210 comprises first titanium end 214, second titanium end 216, and composite skin 218 joined to and extending between first titanium end 214 and second titanium end 216. As another example, composite panel 224 of plurality of composite panels 210 comprises first titanium end 226, second titanium end 228, and composite skin 230 joined to and extending between first titanium end 226 and second titanium end 228. As yet another example, composite panel 236 of plurality of composite panels 210 comprises first titanium end 238, second titanium end 240, and composite skin 242 joined to and extending between first titanium end 238 and second titanium end 240.

In each composite panel of plurality of composite panels 210, the composite skin is joined to the first titanium end and the second titanium end in any desirable fashion. In some illustrative examples, in at least one composite panel of plurality of composite panels 210 the respective composite skin is bonded to the first titanium end and the second titanium end. In some illustrative examples, in at least one composite panel of plurality of composite panels 210 the respective composite skin is adhered to the first titanium end and the second titanium end. In some illustrative examples, in at least one composite panel of plurality of composite panels 210 the respective composite skin is fastened to the first titanium end and the second titanium end.

Composite structure 202 can take any desirable form. In some illustrative examples, composite structure can form part or all of a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a tanker aircraft, a surface ship, a tank, a personnel carrier, a train, a spacecraft, a space station, a satellite, a submarine, an automobile, a power plant, a bridge, a dam, a house, a manufacturing facility, a building, a robot, a robotic arm, a crane, or other suitable type of structure.

In some illustrative examples, composite structure 202 can be aircraft 204. In some illustrative examples, composite structure 202 is wing 206 of aircraft 204. In some illustrative examples, structural skin 266 comprises wing skin 208 of aircraft 204.

In some illustrative examples, each composite panel further comprises a first stepped lap joint between the first titanium end and the composite skin and a second stepped lap joint between the second titanium end and the composite skin. For example, composite panel 212 further comprises stepped lap joint 220 between first titanium end 214 and composite skin 218 and stepped lap joint 222 between second titanium end 216 and composite skin 218. For example, composite panel 224 further comprises stepped lap joint 232 between first titanium end 226 and composite skin 230 and stepped lap joint 234 between second titanium end 228 and composite skin 230. For example, composite panel 236 further comprises stepped lap joint 244 between first titanium end 238 and composite skin 218 and stepped lap joint 222 between second titanium end 216 and composite skin 218.

Structural supports 253 can take any desirable form. In some illustrative examples, structural supports 253 comprise ribs. In some illustrative examples, structural supports 253 comprise spars. Structural supports 253 comprise any desirable material. In some illustrative examples, structural supports 253 comprise a metal. In some illustrative examples, structural supports 253 comprise titanium. In some illustrative examples, structural supports 253 comprise a material different than titanium. In some illustrative examples, when structural supports 253 are a material different than titanium, titanium splice plates are present between structural supports 253 and plurality of composite panels 210.

In some illustrative examples, composite panel 212 and composite panel 224 are fastened to structural support 254. In some illustrative examples, composite panel 212 and composite panel 224 are directly fastened to structural support 254. In some illustrative examples, second titanium end 216 of composite panel 212 and first titanium end 226 of composite panel 224 are directly fastened to structural support 254. In some illustrative examples, composite panel 212 and composite panel 224 are fastened to titanium splice plate 248 and structural support 254.

In some illustrative examples, composite panel 224 and composite panel 236 are fastened to structural support 256. In some illustrative examples, composite panel 224 and composite panel 236 are directly fastened to structural support 256. In some illustrative examples, second titanium end 228 of composite panel 224 and first titanium end 238 of composite panel 236 are directly fastened to structural support 256. In some illustrative examples, composite panel 224 and composite panel 236 are fastened to titanium splice plate 250 and structural support 256.

In some illustrative examples, each composite panel of plurality of composite panels 210 is removably fastened to a titanium splice plate of the titanium splice plates. In this illustrative example, composite panel 212 is fastened to titanium splice plate 248. In this illustrative example, composite panel 224 is attached to titanium splice plate 248 and titanium splice plate 250. In this illustrative example, composite panel 236 is attached to titanium splice plate 250.

Composite structure 202 further comprises fasteners 264 extending through the first titanium end and the second titanium end of each composite panel to connect plurality of composite panels 210 to structural supports 253. Fasteners 264 extend through second titanium end 216 of composite panel 212 to connect composite panel 212 to structural supports 253. Fasteners 264 extend through first titanium end 226 second titanium end 228 of composite panel 224 to connect composite panel 224 to structural supports 253. Fasteners 264 extend through first titanium end 238 of composite panel 236 to connect composite panel 236 to structural supports 253.

In some illustrative examples, fasteners 264 are one-sided fasteners 270. One-sided fasteners 270 allow for one-sided fasteners 270 to be installed from a single side of a respective composite panel. One-sided fasteners 270 allow for a respective composite panel without access inside of composite structure 202.

In some illustrative examples, at least one composite panel of plurality of composite panels 210 comprises more than one titanium structural component forming one of the first titanium end or the second titanium end. In this illustrative example, composite panel 236 of plurality of composite panels 210 comprises more than one titanium structural component forming second titanium end. In this illustrative example, composite panel 236 comprises titanium structural components 258 forming second titanium end 240.

In some illustrative examples, a dividing set of composite plies extends between the more than one titanium structural component to provide an escape path for volatiles. In this illustrative example, dividing set of composite plies 259 extends between titanium structural components 258 to provide escape path 260 for volatiles 262. Although only one titanium end is depicted as having multiple titanium structural components, in some illustrative examples, more than one titanium end comprises multiple titanium structural components. In some illustrative examples, each composite panel of plurality of composite panels 210 has at least one titanium end comprising multiple titanium structural components. In some illustrative examples, each composite panel of plurality of composite panels 210 has both titanium ends comprising more than one titanium structural component so that each titanium end comprises an escape path for volatiles.

In some illustrative examples, plurality of composite panels 210 comprise plurality of access panels 252 removably connected to provide internal access to composite structure 202. In these illustrative examples, each of plurality of composite panels 210 is removable. Removing a composite panel of plurality of composite panels 210 provides access to composite structure 202 to perform maintenance or repair within composite structure 202. In some illustrative examples, plurality of access panels 252 enable maintenance without accessing composite structure 202 through an opposite face or opposite skin.

For example, when plurality of composite panels 210 from structural skin 266 on an upper face of composite structure 202, in some illustrative examples maintenance may be performed through the upper face without access through a lower face of composite structure 202.

To remove a composite panel, such as composite panel 212, one-sided fasteners 270 of the composite panel are loosened. The composite panel, such as composite panel 212, is removed from composite structure 202 to create opening 272 after unfastening one-sided fasteners 270. Internal volume 268 of composite structure 202 can be accessed through opening 272.

In some illustrative examples, composite structure 202 comprises plurality of composite panels 210 fastened to composite structure 202 at respective titanium ends. In some illustrative examples, each composite panel of plurality of composite panels 210 comprises two titanium ends and a composite skin joined to and extending between the two titanium ends.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although three composite panels are depicted in plurality of composite panels 210, any desirable quantity of composite panels can be present. In some illustrative examples, plurality of composite panels 210 comprises more than three composite panels. In some illustrative examples, plurality of composite panels 210 comprises fewer than three composite panels.

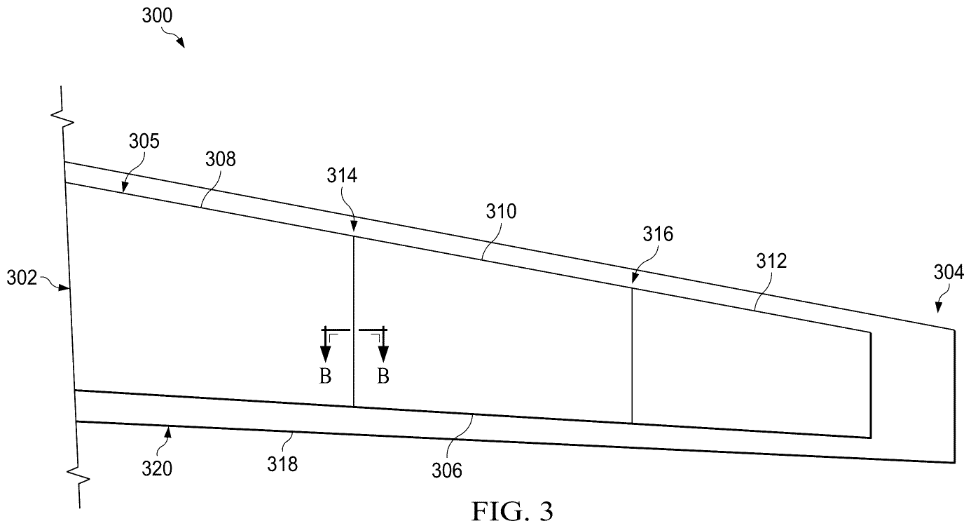

Turning now to FIG. 3, an illustration of a top view of an aircraft wing with a wing skin comprising a plurality of composite panels is depicted in accordance with an illustrative embodiment. View 300 can be top view of wing 102 or wing 104 of aircraft 100 of FIG. 1. View 300 can be a top view of wing 206 of aircraft 204 of FIG. 2.

View 300 is a top view of wing 318. Wing 318 has inboard end 302 and outboard end 304. Wing 318 is a physical implementation of composite structure 202 of FIG. 2. Wing 318 comprises structural supports (not depicted) and structural skin 306 formed by plurality of composite panels 305 fastened to the structural supports. Each composite panel of plurality of composite panels 305 comprises a first titanium end, a second titanium end, and a composite skin joined to and extending between the first titanium end and the second titanium end.

In this illustrative example, plurality of composite panels 305 comprises composite panel 308, composite panel 310, and composite panel 312. Each composite panel of plurality of composite panels 305 is fastened to a metal structural support. In this illustrative example, plurality of composite panels 305 is fastened to wing 318 at respective titanium ends.

In this illustrative example, composite panel 308 and composite panel 310 are joined at joint 314. In this illustrative example, composite panel 310 and composite panel 312 are joined at joint 316.

In this illustrative example, wing 318 takes the form of composite structure 320. In some illustrative examples, plurality of composite panels 305 comprises a plurality of access panels removably connected to provide internal access to composite structure 320. When plurality of composite panels 305 are removably connected to form the plurality of access panels, plurality of composite panels 305 allow for internal access to wing 318.

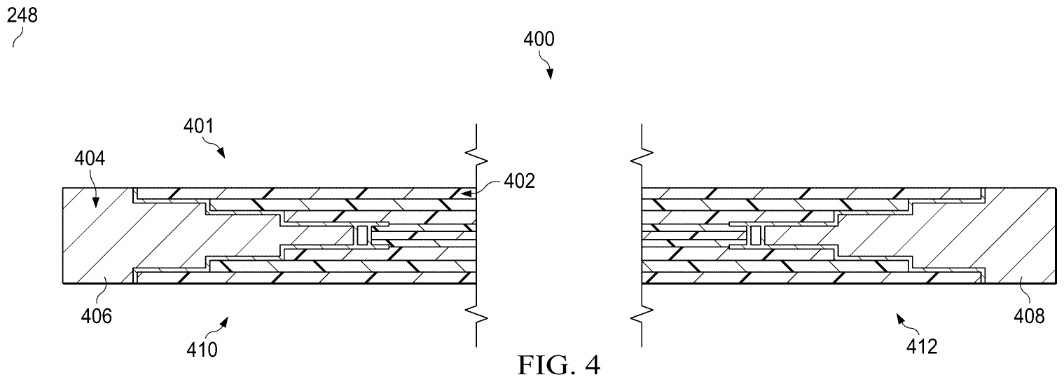

Turning now to FIG. 4, an illustration of a cross-sectional view of a composite panel with metal to composite joints is depicted in accordance with an illustrative embodiment. View 400 is a cross-sectional view of composite panel 401. Composite panel 401 can be a physical implementation of one of plurality of composite panels 210 of FIG. 2. Composite panel 401 can be one of plurality of composite panels 305 of FIG. 3.

Composite panel 401 comprises titanium ends 404 joined to composite skin 402. Composite panel 401 comprises first titanium end 406, second titanium end 408, and composite skin 402 joined to and extending between first titanium end 406 and second titanium end 408. In some illustrative examples, titanium ends 404 form an inboard and an outboard end of composite panel 401.

Composite panel 401 comprises first titanium end 406, composite skin 402, and second titanium end 408. Composite panel 401 comprises first stepped lap joint 410 between first titanium end 406 and composite skin 402 and second stepped lap joint 412 between second titanium end 408 and composite skin 402.

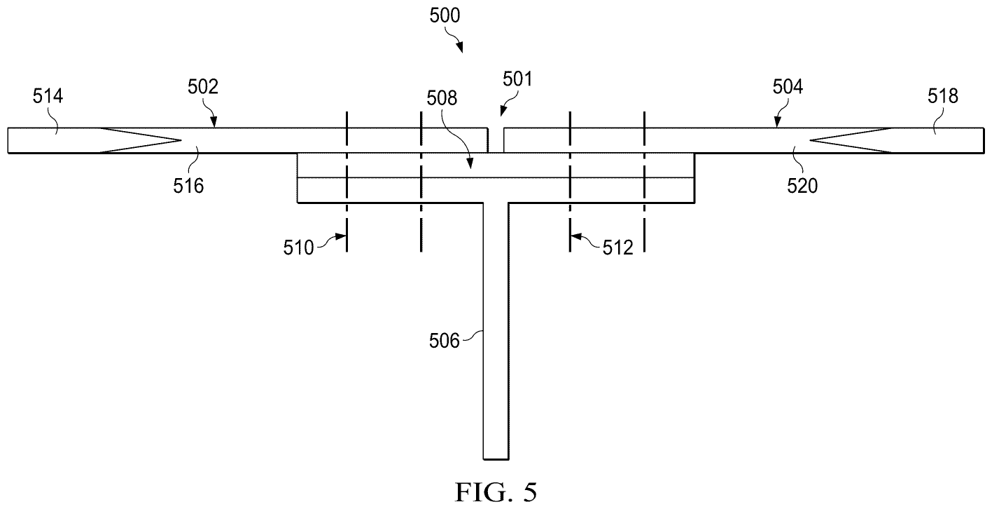

Turning now to FIG. 5, an illustration of a cross-sectional view of composite panels fastened to a structural support is depicted in accordance with an illustrative embodiment. View 500 is a cross-sectional view of a physical implementation of plurality of composite panels 210 fastened to structural supports 253. View 500 can be a view within one of wing 102 or wing 104 of FIG. 1. View 500 can be a cross-sectional view along B-B in FIG. 3. View 500 can be a cross-sectional view of an end of composite panel 401 of FIG. 4 fastened to a structural support.

In view 500, composite panel 502 and composite panel 504 are fastened to structural support 506. In view 500, joint 501 is formed by fastening composite panel 502 and composite panel 504 to structural supports of a composite structure. In this illustrative example, fasteners 510 extend through titanium end 516 of composite panel 502. Composite panel 502 is fastened to structural support 506 with fasteners 510. In this illustrative example, fasteners 512 extend through titanium end 520 of composite panel 504. Composite panel 504 is fastened to structural support 506 with fasteners 512.

In this illustrative example, titanium splice plate 508 is present between composite panel 502 and structural support 506. Titanium splice plate 508 can be present to enable connection of titanium end 516 to structural support 506 formed of a material other than titanium. In some illustrative examples, titanium splice plate 508 can enable connection of titanium end 516 to structural support 506 formed of aluminum.

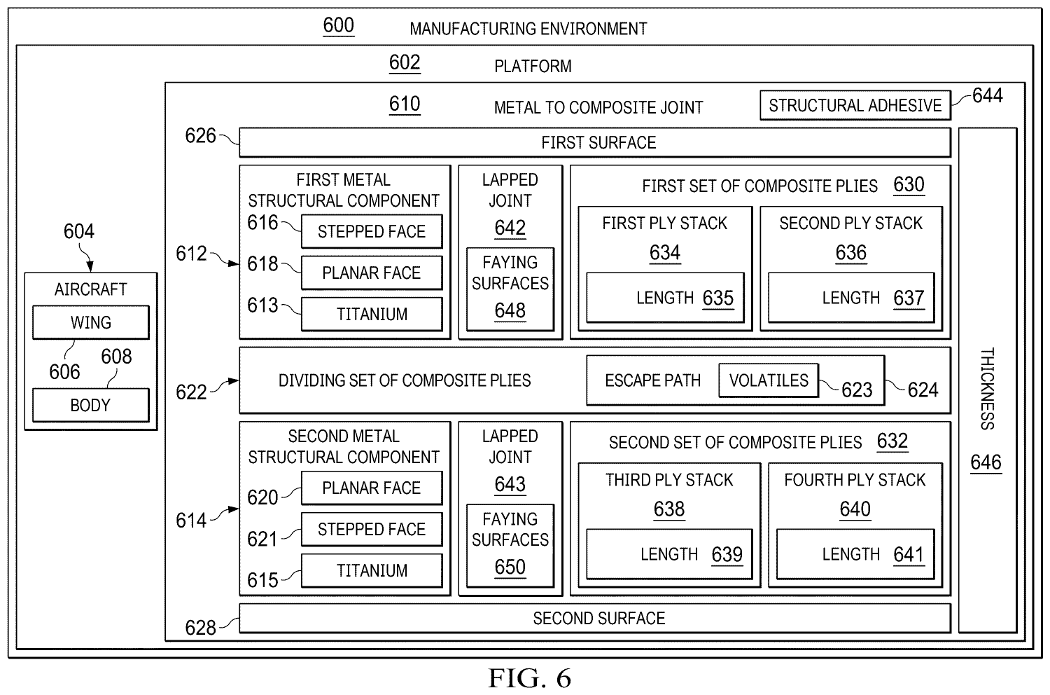

Turning now to FIG. 6, an illustration of a block diagram of a manufacturing environment is depicted in accordance with an illustrative embodiment. Metal to composite joint 610 of platform 602 can be formed in manufacturing environment 600. Metal to composite joint 610 of platform 602 can be a joint in a composite panel of plurality of composite panels 210 of FIG. 2. In some illustrative examples, first metal structural component 612 and second metal structural component 614 are titanium structural components 258 of FIG. 2. Metal to composite joint 610 of platform 602 can be a joint in a composite panel of plurality of composite panels 305 of FIG. 3. Metal to composite joint 610 of platform 602 can be an alternative joint in a composite panel to those depicted in FIGS. 4 and 5. In some illustrative examples, metal to composite joint 610 can be present as an alternative in composite panel 401 of FIG. 4. In some illustrative examples, metal to composite joint 610 can be present as an alternative in at least one of composite panel 502 or composite panel 504 of FIG. 5.

Platform 602 can take a number of different forms. For example, platform 602 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a tanker aircraft, a surface ship, a tank, a personnel carrier, a train, a spacecraft, a space station, a satellite, a submarine, an automobile, a power plant, a bridge, a dam, a house, a manufacturing facility, a building, a robot, a robotic arm, a crane, and other suitable types of platforms.

In some illustrative examples, platform 602 can be aircraft 604. In some illustrative examples, platform 602 is wing 606 of aircraft 604.

In some illustrative examples, aircraft 100 of FIG. 1 can be a physical implementation of aircraft 604. In some illustrative examples, when metal to composite joint 610 is part of aircraft 604, metal to composite joint 610 can connect wing 606 to body 608 of aircraft 604.

Metal to composite joint 610 for platform 602 comprises first metal structural component 612 and second metal structural component 614 with dividing set of composite plies 622 between first metal structural component 612 and second metal structural component 614. As used herein, a “set” of items is one or more items. Dividing set of composite plies 622 comprises one or more composite plies. Dividing set of composite plies 622 provides escape path 624 for volatiles 623 in metal to composite joint 610. Escape path 624 extends interlaminarly within metal to composite joint 610 for platform 602.

Metal to composite joint 610 for platform 602 comprises first metal structural component 612, first set of composite plies 630, second metal structural component 614, second set of composite plies 632, and dividing set of composite plies 622. First metal structural component 612 comprises stepped face 616 and planar face 618. First set of composite plies 630 comprises faying surfaces complementary to stepped face 616 of the first metal structural component 612. Second metal structural component 614 comprises stepped face 661 and planar face 620. Second set of composite plies 632 comprises faying surfaces complementary to stepped face 661 of second metal structural component 614. Dividing set of composite plies 622 between the two metal structural components provides escape path 624 for volatiles 623 between the two metal structural components. In some illustrative examples, first set of composite plies 630 is described as abutting stepped face 616 of the first metal structural component 612. In some illustrative examples, second set of composite plies 632 is described as abutting stepped face 661 of second metal structural component 614.

In some illustrative examples, first set of composite plies 630 is complementary to first metal structural component 612 to form lapped joint 642. Lapped joint 642 comprises faying surfaces 648 of first metal structural component 612 and first set of composite plies 630. In some illustrative examples, second set of composite plies 632 is complementary to second metal structural component 614 to form lapped joint 643. Lapped joint 643 comprises faying surfaces 650 of second metal structural component 614 and second set of composite plies 632. Dividing set of composite plies 622 extends between first set of composite plies 630 and second set of composite plies 632.

In some illustrative examples, dividing set of composite plies 622 extends between and is adhered to the planar faces of the two metal structural components, planar face 618 of first metal structural component 612 and planar face 620 of second metal structural component 614. In some illustrative examples, dividing set of composite plies 622 extends between and is adhered to the stepped faces of the two metal structural components, stepped face 616 of first metal structural component 612 and stepped face 661 of second metal structural component 614.

In some illustrative examples, first metal structural component 612 and second metal structural component 614 comprise titanium. As depicted, first metal structural component 612 comprises titanium 613. As depicted, second metal structural component 614 comprises titanium 615.

Metal to composite joint 610 comprises any desirable quantity of metal structural components with dividing composite plies between the metal structural components. In some illustrative examples, metal to composite joint 610 for platform 602 comprises two metal structural components forming a portion of first surface 626 and a portion of second surface 628 of metal to composite joint 610, and dividing set of composite plies 622 between the two metal structural components providing escape path 624 for volatiles 623 between the two metal structural components.

In some illustrative examples, stepped face 616 of first metal structural component 612 forms a portion of first surface 626. In some illustrative examples, planar face 618 forms a portion of first surface 626. The remainder of first surface 626 is formed by first set of composite plies 630. In some illustrative examples, first ply stack 634 of first set of composite plies 630 forms a portion of first surface 626.

In some illustrative examples, stepped face 661 of second metal structural component 614 forms a portion of second surface 628. In some illustrative examples, planar face 620 forms a portion of second surface 628. The remainder of second surface 628 is formed by second set of composite plies 632. In some illustrative examples, first ply stack 634 of first set of composite plies 630 forms a portion of first surface 626.

First set of composite plies 630 comprises faying surfaces 648 with first metal structural component 612 of the two metal structural components and second set of composite plies 632 comprises faying surfaces 650 with second metal structural component 614 of the two metal structural components to form lapped joint 642 and lapped joint 643. In some illustrative examples, first set of composite plies 630 can be described as abutting first metal structural component 612 of the two metal structural components and second set of composite plies 632 can be described as abutting second metal structural component 614 of the two metal structural components to form lapped joint 642 and lapped joint 643. First set of composite plies 630 forms lapped joint 642 with stepped face 616 of first metal structural component 612. In lapped joint 642, lengths of the ply stacks of first set of composite plies 630 vary to form a joint with stepped face 616 of first metal structural component 612. Second set of composite plies 632 forms lapped joint 643 with stepped face 661 of second metal structural component 614. In lapped joint 643, lengths of the ply stacks of second set of composite plies 632 vary to form a joint with stepped face 661 of second metal structural component 614.

When stepped face 616 forms a portion of first surface 626, first metal structural component 612 extends into first set of composite plies 630. When stepped face 616 forms a portion of first surface 626, longest plies of first set of composite plies 630 form a portion of first surface 626. In these illustrative examples, length 635 of first ply stack 634 forming a portion of first surface 626 is longer than length 637 of plies in second ply stack 636. Second ply stack 636 is farther into metal to composite joint 610 through thickness 646 moving from first surface 626 to second surface 628.

When stepped face 661 forms a portion of second surface 628, second metal structural component 614 extends into second set of composite plies 632. When stepped face 661 forms a portion of second surface 628, longest plies of second set of composite plies 632 form a portion of second surface 628. In these illustrative examples, length 241 of fourth ply stack 640 forming a portion of second surface 628 is longer than length 639 of plies in third ply stack 638. Third ply stack 638 is farther into metal to composite joint 610 through thickness 646 moving from second surface 628 to first surface 626.

In these illustrative examples, first metal structural component 612 and second metal structural component 614 appear to extend into the composite material of first set of composite plies 630 and second set of composite plies 632. In other illustrative examples, composite material of first set of composite plies 630 and second set of composite plies 632 appears to extend between first metal structural component 612 and second metal structural component 614.

When composite material of first set of composite plies 630 and second set of composite plies 632 appears to extend between first metal structural component 612 and second metal structural component 614, composite plies forming first surface 626 and second surface 628 have shortest lengths of first set of composite plies 630 and second set of composite plies 632.

In some illustrative examples, dividing set of composite plies 622 is adhered to the two metal structural components. In some illustrative examples, structural adhesive 644 is applied to at least one of dividing set of composite plies 622, first metal structural component 612 or second metal structural component 614.

Although not depicted in metal to composite joint 610, a third metal structural component can be present between the two metal structural components. In these illustrative examples, dividing set of composite plies 622 is adhered to one of the two metal structural components and the third metal structural component.

In some illustrative examples, the two metal structural components, first metal structural component 612 and second metal structural component 614, are symmetric about a center of metal to composite joint 610 through thickness 646. In other illustrative examples, the two metal structural components, first metal structural component 612 and second metal structural component 614, are asymmetric about a center of metal to composite joint 610 through thickness 646. In some illustrative examples, the two metal structural components, first metal structural component 612 and second metal structural component 614, have a same design. In other illustrative examples, the two metal structural components, first metal structural component 612 and second metal structural component 614, have different designs.

In some illustrative examples, structural adhesive 644 covers faying surfaces of the two metal structural components with first set of composite plies 630 and second set of composite plies 632. In some illustrative examples, structural adhesive 644 runs at least partially between first set of composite plies 630 and dividing set of composite plies 622. In some illustrative examples, structural adhesive 644 runs partially into first set of composite plies 630. In some illustrative examples, structural adhesive 644 runs at least partially between second set of composite plies 632 and dividing set of composite plies 622. In some illustrative examples, structural adhesive 644 runs partially into second set of composite plies 632.

In some illustrative examples, dividing set of composite plies 622 is bonded to the planar faces of the first metal structural component 612 and second metal structural component 614. In some illustrative examples, dividing set of composite plies 622 is bonded to the stepped faces of the first metal structural component 612 and second metal structural component 614.

The illustration of manufacturing environment 600 in FIG. 6 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, more than two metal structural components can be present. As another example, when more than two metal structural components are present, more than one set of dividing composite plies can be present.

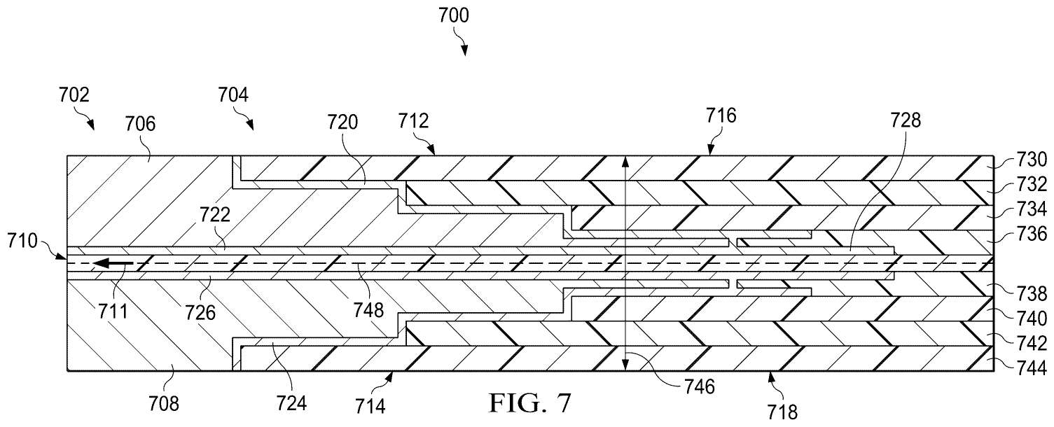

Turning now to FIG. 7, an illustration of a cross-sectional view of a metal to composite joint is depicted in accordance with an illustrative embodiment. Metal to composite joint 700 is a physical implementation of metal to composite joint 610 of FIG. 6. Metal to composite joint 700 can be a joint in a composite panel of plurality of composite panels 210 of FIG. 2. In some illustrative examples, first metal structural component 706 and second metal structural component 708 are titanium structural components 258 of FIG. 2. Metal to composite joint 700 can be a joint in a composite panel of plurality of composite panels 305 of FIG. 3. Metal to composite joint 700 can be an alternative joint in a composite panel to those depicted in FIGS. 4 and 5. In some illustrative examples, metal to composite joint 700 can be present as an alternative in composite panel 401 of FIG. 4. In some illustrative examples, metal to composite joint 700 can be present as an alternative in at least one of composite panel 502 or composite panel 504 of FIG. 5.

Metal to composite joint 700 comprises metal structural components 702 and composite material 704. Metal structural components 702 comprise first metal structural component 706 and second metal structural component 708.

The two metal structural components, first metal structural component 706 and second metal structural component 708, form a portion of first surface 716 and a portion of second surface 718 of the metal to composite joint 700. Dividing set of composite plies 710 is between the two metal structural components providing escape path 711 for volatiles between the two metal structural components. In this illustrative example, volatiles can escape from metal to composite joint 700 by traveling interlaminarly along dividing set of composite plies 710.

In this illustrative example, dividing set of composite plies 710 is adhered to the two metal structural components, first metal structural component 706 and second metal structural component 708. In this illustrative example, dividing set of composite plies 710 is bonded to planar face 722 of first metal structural component 706 and planar face 726 of second metal structural component 708. In this illustrative example, structural adhesive 728 adheres dividing set of composite plies 710 to each of planar face 722 and planar face 726.

Dividing set of composite plies 710 comprises any desirable quantity of composite plies. In some illustrative examples, dividing set of composite plies 710 comprises a stack-up of six composite plies.

First metal structural component 706 comprises stepped face 720 and planar face 722. Second metal structural component 708 comprises stepped face 724 and planar face 726. First set of composite plies 712 comprises faying surfaces complementary to first metal structural component 706 of the two metal structural components. Second set of composite plies 714 comprises faying surfaces complementary to second metal structural component 708 of the two metal structural components. First set of composite plies 712 is complementary to first metal structural component 706. Second set of composite plies 714 is complementary to second metal structural component 708.

First set of composite plies 712 comprises first ply stack 770, second ply stack 772, third ply stack 774, and fourth ply stack 776. Second set of composite plies 714 comprises fifth ply stack 778, sixth ply stack 740, seventh ply stack 742, and eighth ply stack 744.

In some illustrative examples, manufacturing acceptable gaps can be present between first sets of composite plies 712 and stepped face 720 of first metal structural component 706. In some illustrative examples, manufacturing acceptable gaps can be present between second sets of composite plies 714 and stepped face 724 of second metal structural component 708. The volatiles from the gaps can be evacuated through escape path 711 during processing of metal to composite joint 700.

In this illustrative example, the two metal structural components, first metal structural component 706 and second metal structural component 708, are symmetric about center 748 of metal to composite joint 700 through thickness 746. In this illustrative example, planar face 722 faces planar face 726 about center 748 of metal to composite joint 700 through thickness 746. In this illustrative example, the longest composite plies of first set of composite plies 712 form a portion of first surface 716. In this illustrative example, the longest composite plies of second set of composite plies 714 form a portion of second surface 718. In this illustrative example, the two metal structural components appear to “extend into” the composite material as the longest portions of stepped face 720 and stepped face 724 are near center 748.

Dividing set of composite plies 710 extends between first set of composite plies 712 and second set of composite plies 714. First set of composite plies 712 forms a lapped joint with stepped face 720 of first metal structural component 706. Second set of composite plies 714 forms a lapped joint with stepped face 724 of second metal structural component 708.

In this illustrative example, structural adhesive 728 covers faying surfaces of the two metal structural components, first metal structural component 706 and second metal structural component 708, with first set of composite plies 712 and second set of composite plies 714. In this illustrative example, structural adhesive 728 adheres first set of composite plies 712 to first metal structural component 706. In this illustrative examples, structural adhesive 728 adheres second set of composite plies 714 to second metal structural component 708. In this illustrative examples, structural adhesive 728 extends partially between some ply stacks of first set of composite plies 712. As depicted, structural adhesive 728 extends partially between third ply stack 774 and fourth ply stack 776. As depicted, structural adhesive 728 extends partially between fourth ply stack 776 and dividing set of composite plies 710. As depicted, structural adhesive 728 extends partially between dividing set of composite plies 710 and fifth ply stack 778. As depicted, structural adhesive 728 extends partially between fifth ply stack 778 and sixth ply stack 740.

In some illustrative examples, the two metal structural components, first metal structural component 706 and second metal structural component 708, comprise titanium. In some illustrative examples, titanium is used based on its compression strength.

In some illustrative examples, metal to composite joint 700 can be a component of a wing of an aircraft. In some illustrative examples, metal to composite joint 700 can connect a wing of an aircraft to the body of the aircraft.

As depicted, the two metal structural components comprise first metal structural component 706 comprising stepped face 720 and planar face 722, and second metal structural component 708 comprising stepped face 724 and planar face 726. In this illustrative example, the planar faces of first metal structural component 706 and second metal structural component 708 are internal to the platform. In this illustrative example, the stepped faces of first metal structural component 706 and second metal structural component 708 form part of surfaces of the platform.

Metal to composite joint 700 is a non-limiting example. In this illustrative example, metal to composite joint 700 is symmetric about center 748 through thickness 746. In other illustrative examples, metal to composite joint 700 can be asymmetric. Although four metal structural components are depicted, a metal to composite joint of the illustrative examples can have any desirable quantity of metal structural components. Additionally, although metal structural components 702 each extends towards the composite material an equal distance, in other illustrative examples at least one metal structural component can be a different size, different shape, or other different configuration.

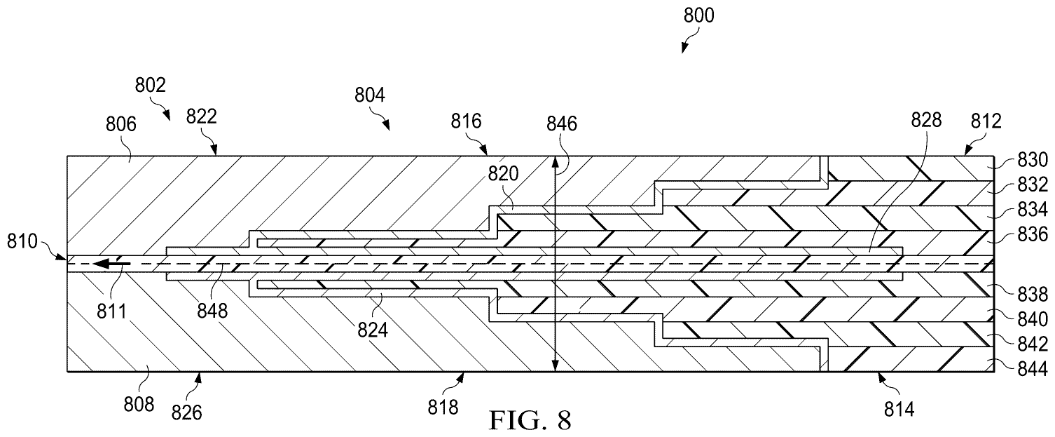

Turning now to FIG. 8, an illustration of a cross-sectional view of a metal to composite joint is depicted in accordance with an illustrative embodiment. Metal to composite joint 800 is a physical implementation of metal to composite joint 610 of FIG. 6. Metal to composite joint 800 can be a joint in a composite panel of plurality of composite panels 210 of FIG. 2. In some illustrative examples, first metal structural component 806 and second metal structural component 808 are titanium structural components 258 of FIG. 2. Metal to composite joint 800 can be a joint in a composite panel of plurality of composite panels 305 of FIG. 3. Metal to composite joint 800 can be an alternative joint in a composite panel to those depicted in FIGS. 4 and 5. In some illustrative examples, metal to composite joint 800 can be present as an alternative in composite panel 401 of FIG. 4. In some illustrative examples, metal to composite joint 800 can be present as an alternative in at least one of composite panel 502 or composite panel 504 of FIG. 5.

Metal to composite joint 800 comprises metal structural components 802 and composite material 804. Metal structural components 802 comprise first metal structural component 806 and second metal structural component 808.

The two metal structural components, first metal structural component 806 and second metal structural component 808, form a portion of first surface 816 and a portion of second surface 818 of the metal to composite joint 800. Dividing set of composite plies 810 is between the two metal structural components providing escape path 811 for volatiles between the two metal structural components. In this illustrative example, volatiles can escape from metal to composite joint 800 by traveling interlaminarly along dividing set of composite plies 810.

In this illustrative example, dividing set of composite plies 810 is adhered to the two metal structural components, first metal structural component 806 and second metal structural component 808. In this illustrative example, dividing set of composite plies 810 is bonded to stepped face 820 of first metal structural component 806 and stepped face 824 of second metal structural component 808. In this illustrative example, structural adhesive 828 adheres dividing set of composite plies 810 to each of stepped face 820 and stepped face 824.

Dividing set of composite plies 810 comprises any desirable quantity of composite plies. In some illustrative examples, dividing set of composite plies 810 comprises a stack-up of six composite plies.

First metal structural component 806 comprises stepped face 820 and planar face 822. Second metal structural component 808 comprises stepped face 824 and planar face 826. First set of composite plies 812 comprises faying surfaces complementary to first metal structural component 806 of the two metal structural components. Second set of composite plies 814 comprises faying surfaces complementary to second metal structural component 808 of the two metal structural components. First set of composite plies 812 is complementary to first metal structural component 806. Second set of composite plies 814 is complementary to second metal structural component 808.

First set of composite plies 812 comprises first ply stack 830, second ply stack 832, third ply stack 834, and fourth ply stack 836. Each stack of first set of composite plies comprises any desirable quantity of plies. In some illustrative examples, each stack of plies comprises six plies. Second set of composite plies 814 comprises fifth ply stack 838, sixth ply stack 480, seventh ply stack 482, and eighth ply stack 844.

In some illustrative examples, manufacturing acceptable gaps can be present between first sets of composite plies 812 and stepped face 820 of first metal structural component 806. In some illustrative examples, manufacturing acceptable gaps can be present between second sets of composite plies 814 and stepped face 824 of second metal structural component 808. The volatiles from the gaps can be evacuated through escape path 811 during processing of metal to composite joint 800.

In this illustrative example, the two metal structural components, first metal structural component 806 and second metal structural component 808, are symmetric about center 848 of metal to composite joint 800 through thickness 846. In this illustrative example, planar face 822 faces away from planar face 826 about center 848 of metal to composite joint 800 through thickness 846. In this illustrative example, stepped face 820 faces towards stepped face 824 about center 848 of metal to composite joint 800 through thickness 846. In this illustrative example, planar face 822 forms a portion of first surface 816. In this illustrative example, the shortest composite plies of first set of composite plies 812 form a portion of first surface 816. In this illustrative example, the shortest composite plies of second set of composite plies 814 form a portion of second surface 818. In this illustrative example, the two metal structural components appear to “extend into” the composite material as the longest portions of stepped face 820 and stepped face 824 are near center 848.

Dividing set of composite plies 810 extends between first set of composite plies 812 and second set of composite plies 814. First set of composite plies 812 forms a lapped joint with stepped face 820 of first metal structural component 806. Second set of composite plies 814 forms a lapped joint with stepped face 824 of second metal structural component 808.

In this illustrative example, structural adhesive 828 covers faying surfaces of the two metal structural components, first metal structural component 806 and second metal structural component 808, with first set of composite plies 812 and second set of composite plies 814. In this illustrative example, structural adhesive 828 adheres first set of composite plies 812 to first metal structural component 806. In this illustrative examples, structural adhesive 828 adheres second set of composite plies 814 to second metal structural component 808. As depicted, structural adhesive 828 extends partially between fourth ply stack 836 and dividing set of composite plies 810. As depicted, structural adhesive 828 extends partially between dividing set of composite plies 810 and fifth ply stack 838.

In some illustrative examples, the two metal structural components, first metal structural component 806 and second metal structural component 808, comprise titanium.

In some illustrative examples, metal to composite joint 800 can be a component of a wing of an aircraft. In some illustrative examples, metal to composite joint 800 can connect a wing of an aircraft to the body of the aircraft.

As depicted, the two metal structural components comprise first metal structural component 806 comprising stepped face 820 and planar face 822, and second metal structural component 808 comprising stepped face 824 and planar face 826. In this illustrative example, the planar faces of first metal structural component 806 and second metal structural component 808 are internal to the platform. In this illustrative example, the stepped faces of first metal structural component 806 and second metal structural component 808 form part of surfaces of the platform.

Metal to composite joint 800 is a non-limiting example. In this illustrative example, metal to composite joint 800 is symmetric about center 848 through thickness 846. In other illustrative examples, metal to composite joint 800 can be asymmetric. Although four metal structural components are depicted, a metal to composite joint of the illustrative examples can have any desirable quantity of metal structural components. Additionally, although metal structural components 802 each extends towards the composite material an equal distance, in other illustrative examples at least one metal structural component can be a different size, different shape, or other different configuration.

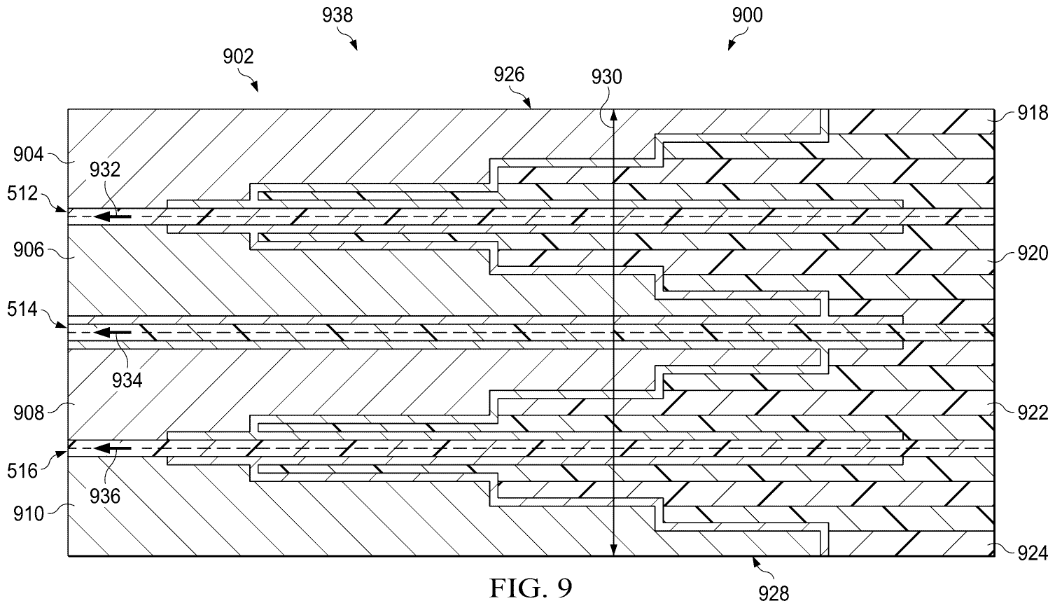

Turning now to FIG. 9, an illustration of a cross-sectional view of a metal to composite joint is depicted in accordance with an illustrative embodiment. Metal to composite joint 900 is a physical implementation of metal to composite joint 610 of FIG. 6. Metal to composite joint 900 can be a joint in a composite panel of plurality of composite panels 210 of FIG. 2. In some illustrative examples, first metal structural component 904 and second metal structural component 906 are titanium structural components 258 of FIG. 2. Metal to composite joint 900 can be a joint in a composite panel of plurality of composite panels 305 of FIG. 3. Metal to composite joint 900 can be an alternative joint in a composite panel to those depicted in FIGS. 4 and 5. In some illustrative examples, metal to composite joint 900 can be present as an alternative in composite panel 401 of FIG. 4. In some illustrative examples, metal to composite joint 900 can be present as an alternative in at least one of composite panel 502 or composite panel 504 of FIG. 5.

Metal to composite joint 900 comprises metal structural components 902 separated by sets of dividing composite plies. Metal structural components 902 comprises first metal structural component 904, second metal structural component 906, third metal structural component 908, and fourth metal structural component 910. In this illustrative example, the sets of dividing composite plies include dividing set of composite plies 912, dividing set of composite plies 914, and dividing set of composite plies 916.

In this illustrative example, metal to composite joint 900 further comprises first set of composite plies 918, second set of composite plies 920, third set of composite plies 922, and fourth set of composite plies 924. In this illustrative example, metal to composite joint 900 comprises first surface 926 and second surface 928. By moving through thickness 930 from first surface 926 to second surface 928 of metal to composite joint 900, each of metal structural components 902, first set of composite plies 918, dividing set of composite plies 912, second set of composite plies 920, dividing set of composite plies 914, third set of composite plies 922, dividing set of composite plies 916, and fourth set of composite plies 924.

In this illustrative example, each of the sets of dividing composite plies provides an escape path for volatiles from metal to composite joint 900. Dividing set of composite plies 912 provides escape path 932 for movement of volatiles. Dividing set of composite plies 914 provides escape path 934 for movement of volatiles. Dividing set of composite plies 916 provides escape path 936 for movement of volatiles.

By moving along escape path 932, escape path 934, or escape path 936, volatiles move interlaminarly through structure 938 having metal to composite joint 900. By providing dividing set of composite plies 912, dividing set of composite plies 914, and dividing set of composite plies 916, structure 938 has improved ability to be evacuated. Metal to composite joint 900 with dividing set of composite plies 912, dividing set of composite plies 914, and dividing set of composite plies 916 has a lower porosity than a structure with a single titanium component extending through thickness 930 without dividing composite plies. Metal to composite joint 900 with dividing set of composite plies 912, dividing set of composite plies 914, and dividing set of composite plies 916 can have a lower manufacturing time without repeated heating for evacuation. Metal to composite joint 900 with dividing set of composite plies 912, dividing set of composite plies 914, and dividing set of composite plies 916 can have improved quality due to the presence of the sets of dividing composite plies.

Metal to composite joint 900 is a non-limiting example. In this illustrative example, metal to composite joint 900 is symmetric about the center of metal to composite joint 900 through thickness 930. In other illustrative examples, metal to composite joint 900 can be asymmetric. Although four metal structural components are depicted, a metal to composite joint of the illustrative examples can have any desirable quantity of metal structural components. Additionally, although metal structural components 902 each extends towards the composite material an equal distance, in other illustrative examples at least one metal structural component can be a different size, different shape, or other different configuration.

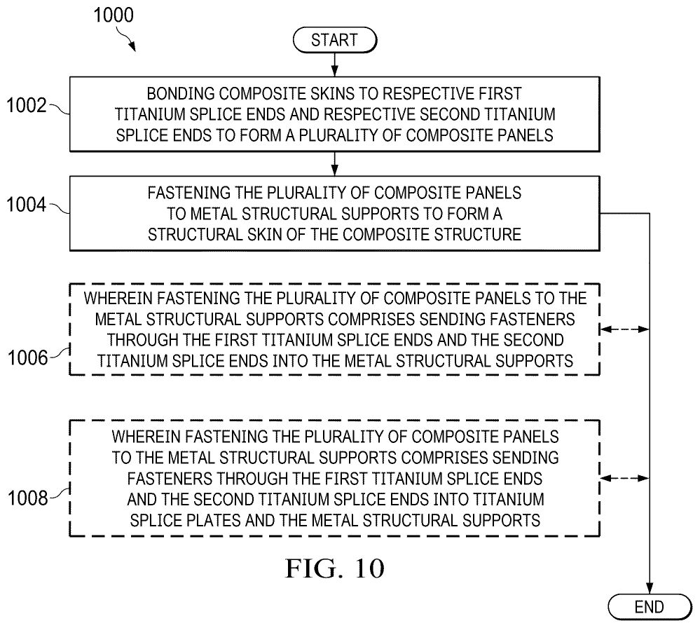

Turning now to FIG. 10, a flowchart of a method of forming a composite structure is depicted in accordance with an illustrative embodiment. Method 1000 can be used to form composite structure 202 of FIG. 2. Method 1000 can be used to form wing 318 of FIG. 3. Composite panel 401 of FIG. 4 can be formed in method 1000. Joint 501 of FIG. 5 can be formed using method 1000. Metal to composite joint 610 of FIG. 6 can be formed in method 1000. Metal to composite joint 700 of FIG. 7 can be formed in method 1000. Metal to composite joint 800 of FIG. 8 can be formed in method 1000. Metal to composite joint 900 of FIG. 9 can be formed in method 1000.

Method 1000 bonds composite skins to respective first titanium ends and respective second titanium ends to form a plurality of composite panels (operation 1002). Method 1000 fastens the plurality of composite panels to structural supports to form a structural skin of the composite structure (operation 1004). Afterwards, method 1000 terminates.

In some illustrative examples, fastening the plurality of composite panels to the structural supports comprises sending fasteners through the first titanium ends and the second titanium ends into the structural supports (operation 1006). In some illustrative examples, fastening the plurality of composite panels to the structural supports comprises sending fasteners through the first titanium ends and the second titanium ends into titanium splice plates and the structural supports (operation 1008).

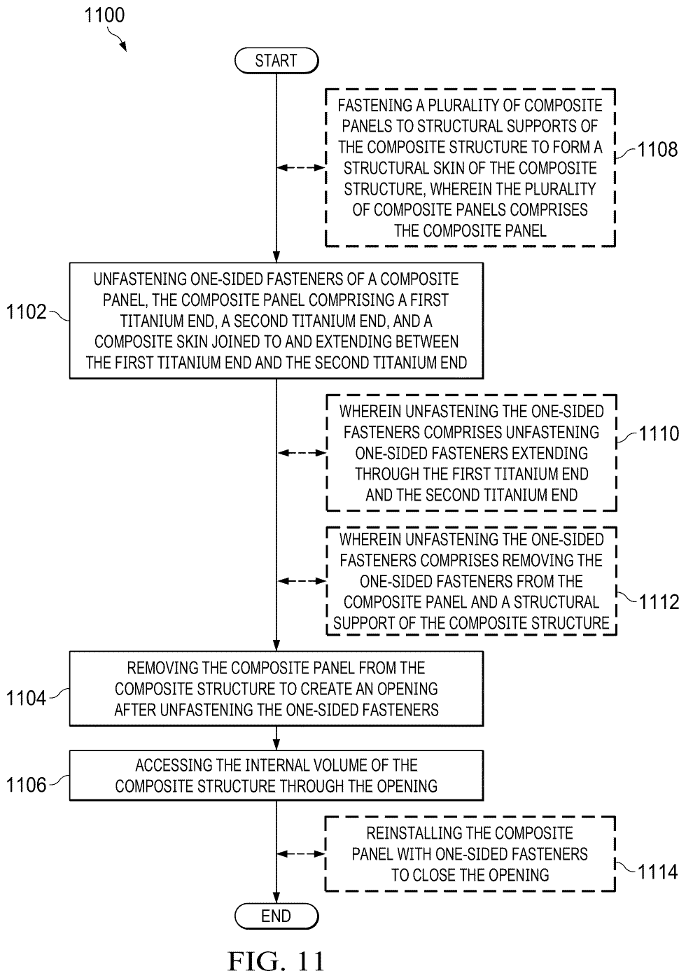

Turning now to FIG. 11, a flowchart of a method of accessing an internal volume of a composite structure is depicted in accordance with an illustrative embodiment. Method 1100 can be used to access internal volume 268 of composite structure 202 of FIG. 2. Method 1100 can be used to access an internal volume of wing 318 of FIG. 3. Composite panel 401 of FIG. 4 can be removed to access an internal volume in method 1100. Fasteners 510 or fasteners 512 of FIG. 5 can be loosened or removed in method 1100. Metal to composite joint 610 of FIG. 6 can be a part of the composite panel in method 1100. Metal to composite joint 700 of FIG. 7 can be a part of the composite panel in method 1100. Metal to composite joint 800 of FIG. 8 can be a part of the composite panel in method 1100. Metal to composite joint 900 of FIG. 9 can be a part of the composite panel in method 1100.

Method 1100 loosens one-sided fasteners of a composite panel are loosened, the composite panel comprising a first titanium end, a second titanium end, and a composite skin joined to and extending between the first titanium end and the second titanium end (operation 1102). Method 1100 removes the composite panel from the composite structure to create an opening after unfastening the one-sided fasteners (operation 1104). Method 1100 accesses the internal volume of the composite structure through the opening (operation 1106). Afterwards, method 1100 terminates.

In some illustrative examples, the composite panel can be referred to as an access panel. Removing the composite panel provides access to an internal volume without dedicated access holes.

In some illustrative examples composite structure comprises a panelized structural skin. In some illustrative examples, a panelized structural skin comprises a plurality of composite panels.

In some illustrative examples, method 1100 fastens a plurality of composite panels to structural supports of the composite structure to form a structural skin of the composite structure, wherein the plurality of composite panels comprises the composite panel (operation 1108). The plurality of composite panels can provide multiple locations for accessing the interior volume of the composite structure.

In some illustrative examples, unfastening the one-sided fasteners comprises unfastening one-sided fasteners extending through the first titanium end and the second titanium end (operation 1110). In some illustrative examples, unfastening the one-sided fasteners comprises removing the one-sided fasteners from the composite panel and a structural support of the composite structure (operation 1112). In some illustrative examples, the one-sided fasteners can be reused to reinstall the composite panel.

In some illustrative examples, method 1100 further comprises reinstalling the composite panel with one-sided fasteners to close the opening (operation 1114). In some illustrative examples, the composite panel is reinstalled with new one sided fasteners.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1006 through operation 1008 may be optional.

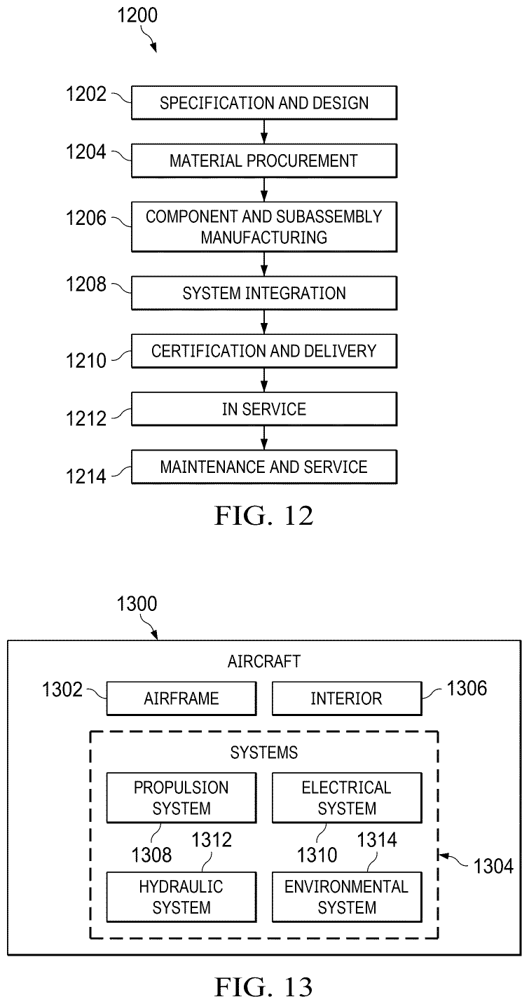

Illustrative embodiments of the present disclosure may be described in the context of aircraft manufacturing and service method 1200 as shown in FIG. 12 and aircraft 1300 as shown in FIG. 13. Turning first to FIG. 12, an illustration of an aircraft manufacturing and service method in a form of a block diagram is depicted in accordance with an illustrative embodiment. During pre-production, aircraft manufacturing and service method 1200 may include specification and design 1202 of aircraft 1300 in FIG. 13 and material procurement 1204.

During production, component and subassembly manufacturing 1206 and system integration 1208 of aircraft 1300 takes place. Thereafter, aircraft 1300 may go through certification and delivery 1210 in order to be placed in service 1212. While in service 1212 by a customer, aircraft 1300 is scheduled for routine maintenance and service 1214, which may include modification, reconfiguration, refurbishment, or other maintenance and service.

Each of the processes of aircraft manufacturing and service method 1200 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 13, an illustration of an aircraft in a form of a block diagram is depicted in which an illustrative embodiment may be implemented. In this example, aircraft 1300 is produced by aircraft manufacturing and service method 1200 of FIG. 12 and may include airframe 1302 with plurality of systems 1304 and interior 1306. Examples of systems 1304 include one or more of propulsion system 1308, electrical system 1310, hydraulic system 1312, and environmental system 1314. Any number of other systems may be included.

Apparatuses and methods embodied herein may be employed during at least one of the stages of aircraft manufacturing and service method 1200. One or more illustrative embodiments may be manufactured or used during at least one of component and subassembly manufacturing 1206, system integration 1208, in service 1212, or maintenance and service 1214 of FIG. 12.

The illustrative examples enable design and fabrication of large scale composite skins with titanium splices on both ends. The illustrative examples enable design and fabrication of large scale composite wing skins with titanium splices on both ends of the wing skins (inboard and outboard ends). The illustrative examples can reduce weight. Composite panels of the illustrative examples can enable a multi-piece wing box. Composite panels of the illustrative examples can enable wing skin panelizing.

The illustrative examples provide a method of panelizing a wing and using fasteners through a spliced joint, doubler and into substructure (spar/rib). The illustrative examples allow access to the interior of a wing without access doors. The panelizing in the illustrative examples can allow less lower skin access holes or even no holes. The illustrative examples provide more than one panel in the chordwise direction which is spliced together.

Panelizing of the wing allows fabrication of a thinner wing than using conventional designs. The panelized wing allows access by removing a wing skin panel instead of through access holes. Lower profile wings can provide improved performance.

The plurality of composite panels are connected to a metal substructure. In some illustrative examples, the substructure can be aluminum and titanium splice plates are included.

The illustrative examples handle structural loads. Using titanium ends can reduce panel gages, especially at Nacelle attach points, landing gear attach points and outboard ends. Conventional composite joints have an increased thickness/gauge at the joint, which increases weight. With titanium ends, the composite panels of the illustrative examples can be thinner with an equivalent strength to conventional composite joints. The composite panels of the illustrative examples reduce weight and present a more efficient design. Improvements in weight and efficiency could be seen at nacelle padups, landing gear and outboard ends.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A composite structure comprising:
a structural support; and
a structural skin comprising a composite panel comprising a first titanium end, a second titanium end, and a composite skin joined to and extending between the first titanium end and the second titanium end.

2. The composite structure of claim 1, wherein the structural skin comprises a wing skin of an aircraft.

3. The composite structure of claim 1, wherein the composite panel further comprises a first stepped lap joint between the first titanium end and the composite skin and a second stepped lap joint between the second titanium end and the composite skin.

4. The composite structure of claim 1 further comprising:
a titanium splice plates between the structural support and the composite panel.

5. The composite structure of claim 4, wherein the composite panel is removably fastened to a titanium splice plate.

6. The composite structure of claim 1 further comprising:
fasteners extending through the first titanium end and the second titanium end of the composite panel to connect composite panel to the structural support.

7. (canceled)

8. The composite structure of claim 1, wherein the composite panel is an access panel removably connected to provide internal access to the composite structure.

9. The composite structure of claim 1, wherein the composite panel comprises more than one titanium structural component forming one of the first titanium end or the second titanium end.

10. The composite structure of claim 8, wherein a dividing set of composite plies extends between the more than one titanium structural component to provide an escape path for volatiles.

11. A composite structure comprising:
a composite panel fastened to the composite structure at titanium ends, the composite panel comprising:
two titanium ends; and
a composite skin joined to and extending between the two titanium ends.

12. The composite structure of claim 10, wherein each composite panel further comprises a first stepped lap joint between a first titanium end and the composite skin and a second stepped lap joint between a second titanium end and the composite skin.

13. The composite structure of claim 11, wherein the composite panel is one of a plurality of composite panels, and wherein the plurality of composite panels comprises a wing skin of an aircraft.

14. The composite structure of claim 11, wherein the composite panel is one of a plurality of composite panels and further comprising:
titanium splice plates joining the plurality of composite panels.

15. The composite structure of claim 14, wherein each composite panel of the plurality of composite panels is removably fastened to a titanium splice plate of the titanium splice plates.

16. The composite structure of claim 11, wherein the composite panel is an access panel removably connected to provide internal access to the composite structure.

17. The composite structure of claim 11, wherein the composite panel comprises more than one titanium structural component forming a titanium end.

18. The composite structure of claim 17, wherein a dividing set of composite plies extends between the more than one titanium structural component to provide an escape path for volatiles.

19. A method of forming a composite structure comprising:
bonding composite skins to respective first titanium ends and respective second titanium ends to form a plurality of composite panels; and
fastening the plurality of composite panels to structural supports to form a structural skin of the composite structure.

20. The method of claim 19, wherein fastening the plurality of composite panels to the structural supports comprises sending fasteners through the first titanium ends and the second titanium ends into the structural supports.

21. The method of claim 19, wherein fastening the plurality of composite panels to the structural supports comprises sending fasteners through the first titanium ends and the second titanium ends into titanium splice plates and the structural supports.

22. A method of accessing an internal volume of a composite structure comprising:
unfastening one-sided fasteners of a composite panel, the composite panel comprising a first titanium end, a second titanium end, and a composite skin joined to and extending between the first titanium end and the second titanium end;
removing the composite panel from the composite structure to create a opening after unfastening the one-sided fasteners; and
accessing the internal volume of the composite structure through the opening.

23. The method of claim 22 further comprising:
reinstalling the composite panel with one-sided fasteners to close the opening.

24. The method of claim 22, wherein unfastening the one-sided fasteners comprises unfastening one-sided fasteners extending through the first titanium end and the second titanium end.

25. The method of claim 22 further comprising:
fastening a plurality of composite panels to structural supports of the composite structure to form a structural skin of the composite structure, wherein the plurality of composite panels comprises the composite panel.

26. The method of claim 22, wherein unfastening the one-sided fasteners comprises removing the one-sided fasteners from the composite panel and a structural support of the composite structure.
